(19) United States
(12) Patent Application Publication
(10) Pub. No.: US 2005/0246634 A1
(43) Pub. Date: Nov. 3, 2005

(54) Synchronized sharing of a dynamically updated image

(76) Inventors: Andrew Ortwein, Lexington, KY (US); James Stuart Johnston, Lexington, KY (US); William Michael Quinn, Lexington, KY (US); Kevin Joel Solie, Lexington, KY (US); Raymond Rice Hornback JR., Lexington, KY (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(21) Appl. No.: 10/837,980

(22) Filed: May 3, 2004

(51) Int. Cl. G06F 17/21

(52) U.S. Cl. 715/530; 715/513; 709/203

(57) ABSTRACT

Described is a method for synchronously sharing a dynamically updated image in a sharing display of a sharing computer with a viewer device. The method can be performed with a variety of viewer devices having web browsing capability. A server caches an HTML page representing at least a portion of the sharing display. An automated request for an updated image in the sharing display is sent to the server. A timestamp in the request indicates the current version of the image on the viewer device. The timestamp is compared with a timestamp of a corresponding image in the HTML page. If the timestamps are not equal, the server sends an updated image to the viewer device.

### FIELD OF THE INVENTION

The invention relates generally to a method for sharing of a dynamic image. In particular, the invention relates to a method for synchronous sharing of a dynamically updated image on a host computer with one or more viewers.

### BACKGROUND OF THE INVENTION

The ability to share synchronous information is critical in the current marketplace. One popular method of sharing information is based on a dynamically updated image, such as images used in slide presentations, desktop sharing, or mapped seating presentations for real-time ticket purchases for concerts and sporting events. For example, conventional application sharing is based on a “sharing” computer (i.e., host computer) that distributes imagery of an application operating on the sharing computer to one or more viewer devices over a computer network. The imagery typically includes screens rendered in association with the operation of the shared application and the presentation of a cursor or pointer. Generally, the imagery includes only discrete samples, or “snap shots” of the sharing display associated with the sharing computer. Thus the content presented on viewer displays appears to be real time sharing of the sharing display, however, the viewers actually observe only a sampling of the sharing display. This method of sharing requires synchronization among all viewers. Continuing advancements in technology have resulted in an increase in the number of different types of hardware, software, data formats, and communication protocols used by viewers. It is no longer satisfactory to build an application that works on only one desktop computer platform. Laptops, PDAs, and web-enabled cell phones, each capable of implementing a variety of operating systems, are just a few examples of the broad range of devices that can be used for the exchange of information.

With a variety in technology available to viewers, sharing a synchronized dynamically updated image from one computer to an audience of viewer devices becomes complex. Different hardware architectures and operating systems require a software vendor to develop application code for a product that accommodates each possible viewer device. As new technologies emerge, the software vendor must update the product to ensure compliance with all viewer devices. In addition, the resources for viewer devices can vary greatly. For example, many computer desktop machines are sufficiently robust to support memory-intensive applications, ActiveX commands, or a java runtime environment. Other devices, such as PDAs and cell phones, have a limited ability and can only accommodate lightweight applications.

Problems can arise with the installation of the product on the viewer device. First, the installation creates a delay in the user experience the first time the user attempts to view a shared image. Whether the product is a custom application, a device driver, or even a simple java applet, the time necessary to complete installation can result in the loss of information available for sharing and possible viewer confusion during the installation process. Also, many environments employ security measures that prevent installation of software on demand, such as applications that use ActiveX.

For many networks, there is a desire to minimize transmitted data. Unfortunately, many communication protocols used for synchronously sharing a dynamically updated image with an audience are associated with a high amount of transmitted data, congesting the network and often requiring the audience to maintain a broadband connection to the network. Network firewalls and proxy servers can also block non-standard ports and protocols, making it difficult for communication between the sharing computer and the viewer device. Modifying the network to accommodate for this communication can compromise security.

What is needed is a method for synchronously sharing a dynamically updated image between a sharing computer and one or more viewer devices. The present invention satisfies this need and provides additional advantages.

### SUMMARY OF THE INVENTION

In one aspect, the invention features a method for synchronously sharing a dynamically updated image in a sharing display of a sharing computer with a viewer device. An automated HTTP request for an updated image in the sharing display is sent to a server. The server stores a set of images representing at least a portion of the sharing display. The automated HTTP request has a timestamp for an image displayed on the viewer device. The server compares the timestamp of the image displayed on the viewer device with a timestamp of a server image. If the timestamp of the image displayed on the viewer device is different from the timestamp of the server image, the server image is sent to the viewer device. In one embodiment, the method also includes sending an automated request for an updated HTML page to the server. The automated request has a timestamp for an HTML page on the viewer device. An HTML page having a server timestamp and representing the layout of the images in at least a portion of the sharing display is stored on the server. The HTML page is sent to the viewer device if the timestamp of the HTML page on the viewer device is different from the timestamp of the HTML page stored on the server.

In another aspect, the invention features a computer program product for use with a computer system having a server, a viewer device and a sharing computer having a sharing display. The computer program product includes a computer useable medium having program code for sending an automated HTTP request for an updated image in the sharing display to a server. A set of images representing at least a portion of the sharing display is stored on the server. The automated HTTP request has a timestamp for an image displayed on the viewer device. The computer program product also includes program code for comparing the timestamp of the image displayed on the viewer device with a timestamp of a server image and program code for sending the server image to the viewer device if the timestamp of the image displayed on the viewer device is different from the timestamp of the server image.

In another aspect, the invention features a computer data signal embodied in a carrier wave for use with a computer system having a server, a viewer device and a sharing computer having a sharing display. The computer data signal includes program code for sending an automated HTTP request for an updated image in the sharing display to a server. The server stores a set of images representing at least a portion of the sharing display. The automated HTTP request has a timestamp for an image displayed on the viewer device. The computer data signal also includes program code for comparing the timestamp of the image displayed on the viewer device with a timestamp of a server image and program code for sending the server image to the viewer device if the timestamp of the image displayed on the viewer device is different from the timestamp of the server image.

In another aspect, the invention features an apparatus for synchronously sharing a dynamically updated image in a sharing display of a sharing computer with a viewer device. The apparatus includes means for sending an automated HTTP request for an updated image in the sharing display to a server. A set of images representing at least a portion of the sharing display is stored on the server. The automated HTTP request has a timestamp for an image displayed on the viewer device. The apparatus also includes means for comparing the timestamp of the image displayed on the viewer device with a timestamp of a server image and means for sending the server image to the viewer device if the timestamp of the image displayed on the viewer device is different from the timestamp of the server image.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is an illustration of a networked environment having a host computer, a server and viewer devices.

FIG. 2 is a block diagram of a conventional personal computer system in which aspects of the invention may be incorporated.

FIG. 3 is a graphical representation of an HTML page including multiple images in accordance with the invention.

FIGS. 4A and 4B are, in combination, a flowchart representation of an embodiment of a method for sharing an updated HTML page between a sharing computer and a viewer device in accordance with the invention.

FIGS. 5A and 5B are, in combination, a flowchart representation of an embodiment of a method for synchronously sharing a dynamically updated image between a sharing computer and a viewer device in accordance with the invention.

### DETAILED DESCRIPTION

In brief overview the present invention relates to a method for synchronously sharing a dynamically updated image in a sharing display of a sharing computer with a viewer device. A user wishing to share at least a portion of a display of the sharing computer with one or more remote viewers posts images to be included in a hyper text markup language (HTML) page on a server. Posting can occur whenever a portion of the sharing display is changed as compared to the corresponding image on the server. Viewers see the display locally on various types of viewer devices regardless of the hardware architecture and operating system implemented on the viewer device. Automated HTTP requests are sent from the viewer devices to the server to retrieve new (i.e., updated) images contained in the HTML page when they become available. Similarly, the viewer devices can send automated HTTP requests to retrieve updated HTML pages from the server in case there is a modified HTML page on the server.

Transmitting only modified images and HTML pages significantly reduces the bandwidth and resource allocations required to maintain synchronous sharing of displayed information. Advantageously, the use of HTML with hyper text transfer protocol (HTTP) enables a wide variety of viewer devices with web browsing capability to access a sharing session without requiring significant hardware resources (e.g., available random access memory (RAM) and central processing unit (CPU) speed) or platform functionality (e.g., ActiveX or Java browser functionality). Because HTTP port 80 is open in nearly all business networks, no added customization is required and no additional security threats are introduced. Moreover, the task of developing software to accommodate different types of viewer devices is simplified and future devices utilizing technology not yet developed can be accommodated.

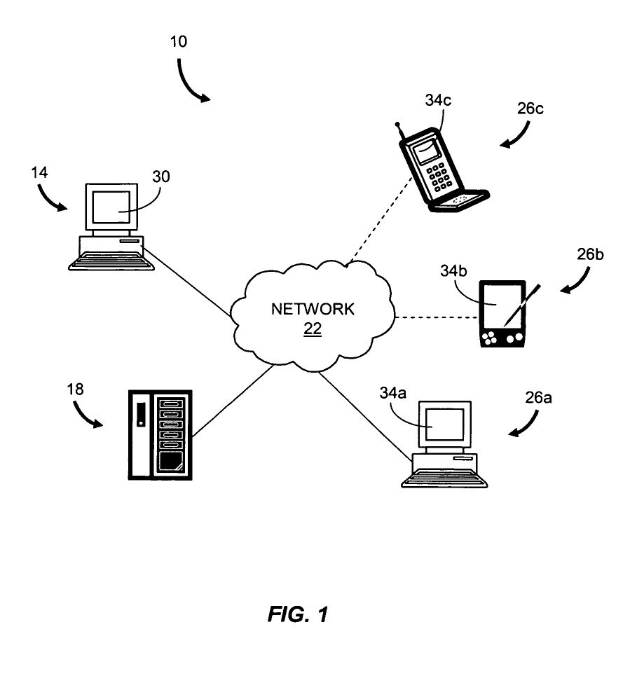

Referring to FIG. 1, a networked environment 10 in which the invention may be practiced includes a sharing computer 14 in communication with a server 18 over a network 22. Various types of viewing devices 26 also communicate with the server 18 through the network 22. The network 22 can be an intranet, the Internet or any network or combination of networks that supports the transmission of data between the server 18, the sharing computer 14 and the viewing devices 26. By way of illustration, the viewing devices 26 includes a personal computer (PC) 26a, a personal digital assistant (PDA) 26b and a web enabled cell phone 26c, although it should be recognized that other devices capable of data communication with the server 18 and having a user display are contemplated for use as viewer devices 26. The sharing computer 14 has a display 30 for presenting graphical information to a user. Similarly, each viewer device 26 has a display 34 to present graphical information to a respective viewer.

During an application sharing session, content shown on the sharing display 30 is transmitted as display data to the server 18 and stored (i.e., cached) for access by the viewer devices 26. Display data can include data representing the entire area of the sharing display 30. Alternatively, display data may represent only a portion of the sharing display 30, such as a window allocated to the application being shared. Display data is preferably transmitted to the server 18 only when content in the sharing display 30 or application window changes.

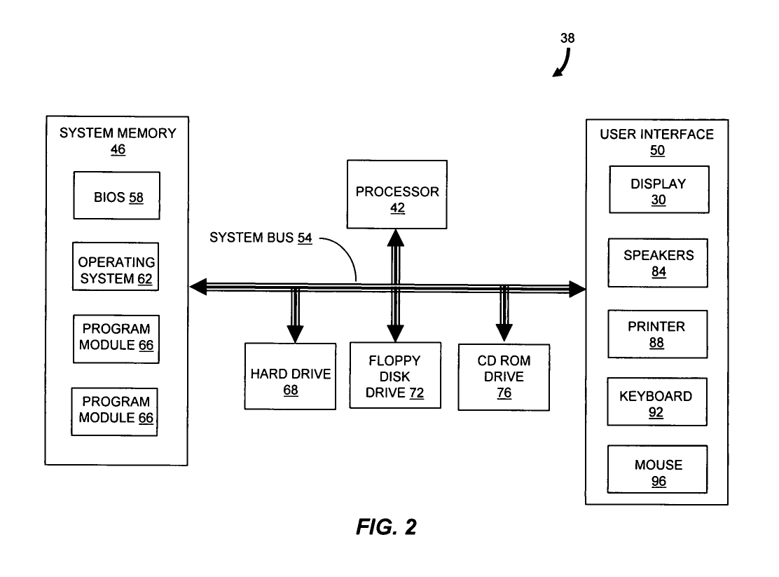

FIG. 2 is a functional block diagram of a conventional personal computer (PC) 38 which in one embodiment is the sharing computer 14 and in another embodiment is the viewing device 26a of FIG. 1. The PC 38 includes a processor 42, a system memory 46 and a user interface 50 coupled to each other over a system bus 54. The system memory 46 includes read-only memory (ROM) and RAM. Basic routines used to transfer information between the components of the PC 38 at certain times, such as during startup, are included in a basic input/output system (BIOS) 58 in ROM. The BIOS 58 provides an interface between the PC's operating system 62 (e.g., Windows, Mac OS, Linux) and the specific hardware configuration of the PC 38, including the processor 42 and the system memory 46. The system memory 46 also includes various program modules 66 such as word processing applications, presentation applications and spreadsheet applications.

The PC 38 generally includes other components, for example one or more hard disk drives 68, magnetic disk drives 72, optical disk drives 76 and the like. The drives 68, 72, 76 enable read from and write to operations for various forms of computer-readable media and allow for non-volatile storage of computer readable instructions, data structures and other data. The user interface 50 includes a display 30 (or 34a for a viewer device 26a) and other peripheral output devices, such as speakers 84 and a printer 88, connected through various interface modules (not shown) to the system bus 54. Commands and information are entered into the PC 38 through input devices such as a keyboard 92 and a mouse 96.

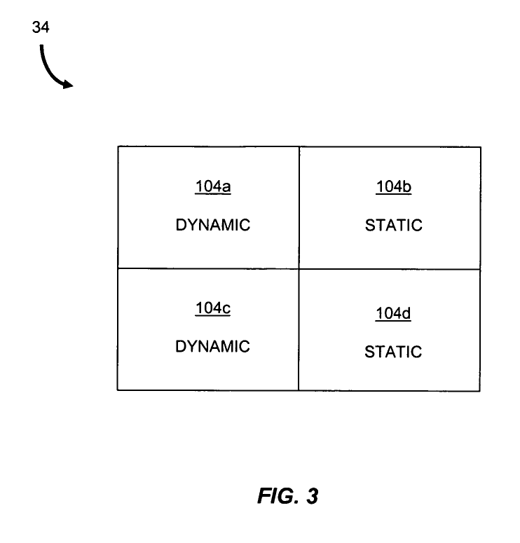

FIG. 3 is a graphical depiction of the display 34 of a viewer device 26. In the illustrative example, the display 34 shows all the content of the sharing display 30. In other embodiments, the content shown on the viewer device 26 is limited to the content of one or more windows presented on the sharing display 30. The server 22 provides one or more HTML pages that define the layout of images, or regions, 104a to 104d (generally 104) according to the application being shared. Each image 104 corresponds to a predefined portion of the sharing display 30 and is not generally representative of a complete conventional digital image. Each image 104 can dynamically change independent of the other images 104.

When a viewer first joins a sharing session, the full set of images 104 is provided to the viewer device 26 in response to an initial HTTP request and displayed according to the HTML defined layout. Each image 104 is referred to and accessed by a uniform resource locator (URL). Subsequent HTTP requests from the viewer device 26 to the server 18 for an updated image 104 can result in the server 18 responding with only those images 104 that have changed from the respective images 104 currently displayed on the viewer device 26. This enables efficient use of the available bandwidth for communication between the server 18 and the viewer device 26. In one embodiment, the viewer device 26 only requests updates to certain indexed images 104 in the HTML page. For example, the layout of the HTML page can define the layout of images 104a, 104c subject to change and static images 104b, 104d. Thus the viewer device 26 in such an embodiment generates HTTP update requests only for the dynamic images 104a, 104c. Advantageously, the rate at which updated images are requested (i.e., refresh rate) can be different according to the requirements and limitations of each viewer device 26. Thus one viewer device 26 may utilize a slower refresh rate without degrading the experience of other viewers.

The viewer device 26 can use HTTP to request updates to the layout or “structure” for the images 104 in the viewer display 34. Such HTTP requests can be at a lower frequency than HTTP requests for updated images 104 if the layout is known to change infrequently. If the layout does not change, an HTTP response indicating a lack of change is transmitted back to the viewer device 26 to preserve bandwidth.

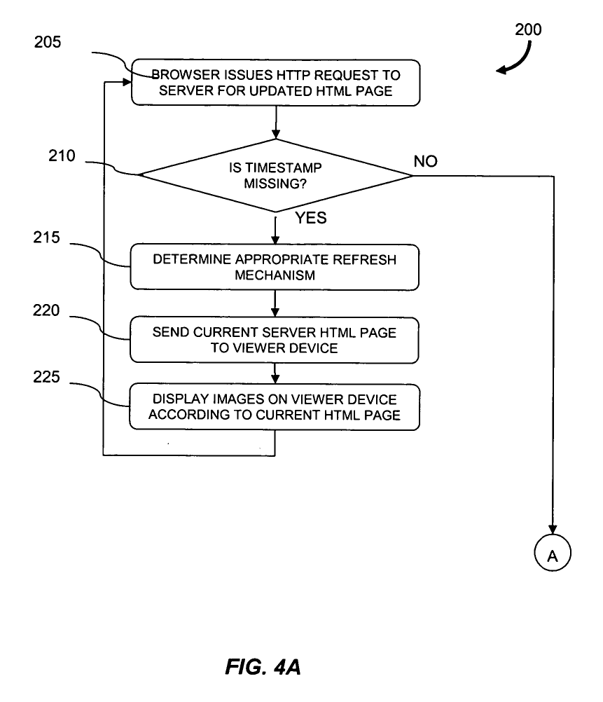

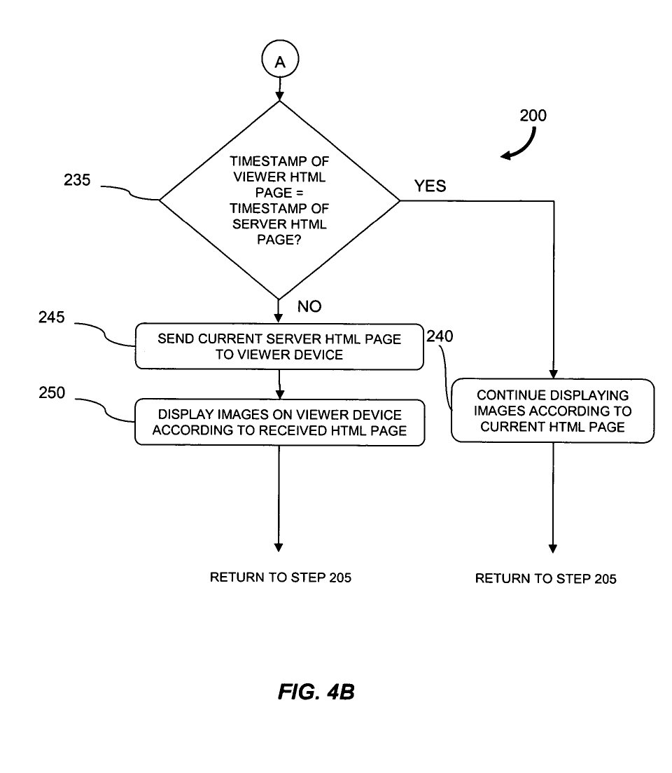

FIGS. 4A and 4B show a flowchart of an embodiment of a method 200 for synchronously sharing a dynamically updated display according to the invention. The display can be the entire viewable portion of an observable screen (i.e., full monitor). Conversely, the display can be a portion of the observable screen such as an application window. The method 200 includes issuing (step 205) from a browser on a viewer device 26 an HTTP request for an HTML page representing the layout of the shared display 30. The HTTP request can be made when the viewer first joins a sharing session by an affirmative action (e.g. mouse clicking) to start the viewer's session. Alternatively, the request can be automatically issued by the viewer device 26. Automated HTTP requests can be issued periodically and may be based, for example, on the communication bandwidth of the link between the viewer device 26 and the server 18.

Each HTTP request, other than a first request at the start of a sharing session, includes a timestamp indicating the server assigned timestamp for the HTML page. If it is determined (step 210) that the timestamp is missing and, therefore, that the request is a first request, the appropriate refresh mechanism for the viewer device 26 is determined (step 215) by examining data in the request indicating the device environment. For example, the HTTP request can inform the server 18 that the viewer device 26 utilizes a Macintosh operating system for which a javascript refresh mechanism is appropriate. In another example, the request can indicate that the viewer device 26 is a particular PDA for which a metatag refresh mechanism embodied in the HTML page is appropriate. The server 18 responds by sending (step 220) the HTML page currently available on the server 18 to the viewer device 26 with an associated server timestamp and the embedded refresh mechanism. The viewer device 26 displays (step 225) images 104 according to the layout described by the HTML page. The method 200 then returns to step 205 after a predetermined time to issue a new HTTP request.

If it is determined (step 210) that the server timestamp is not missing, the timestamp of the last accessed HTML page is compared (step 235) with the timestamp of the current server HTML page. If the server timestamps are equal, the viewer device 26 continues to display (step 240) images 104 according to the layout defined by the current HTML page and the method 200 returns to step 205 after the predetermined time to issue a new HTTP request. However, if the server timestamps differ because a new (i.e., updated) HTML page is available, the server 18 responds by transmitting (step 245) the new HTML page. The images 104 for the updated HTML page are then displayed (step 250) on the viewer device 26 and the method 200 returns to step 205 after the predetermined time to issue a new HTTP request.

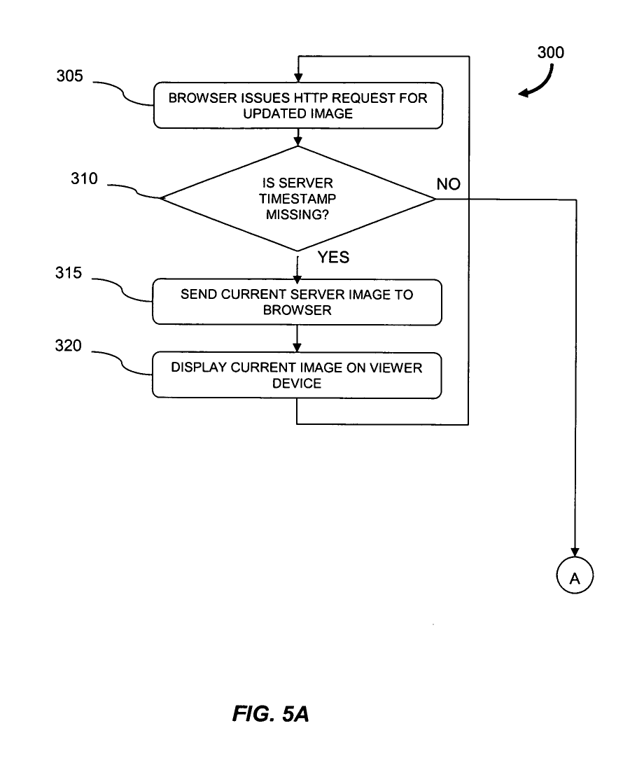

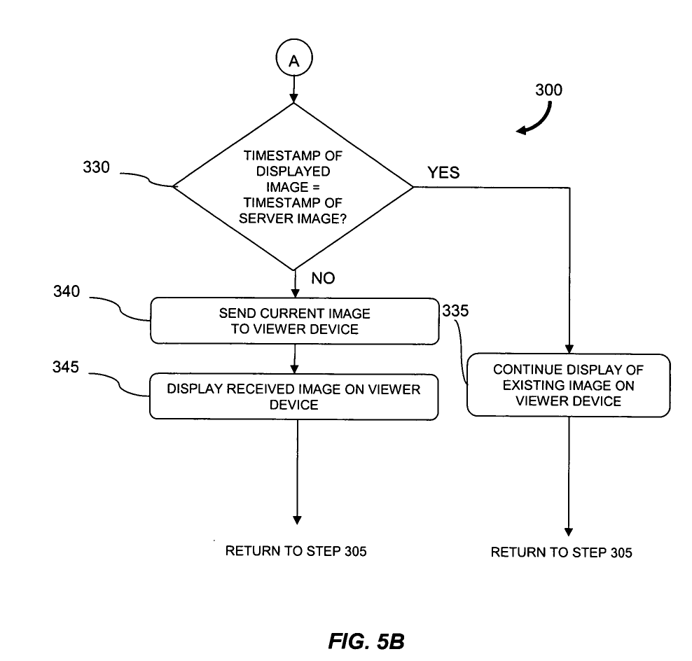

FIGS. 5A and 5B show a flowchart of an embodiment of a method 300 for synchronously sharing a dynamically updated image in a sharing display according to the invention. The method can be executed independent of, or in combination with, the method 200 of FIG. 4. In one embodiment, the method 300 provides for refreshing one or more images 104 at a different rate than the refreshing of the HTML page according to the method 200 of FIG. 4. For example, different refresh rates accommodate the infrequent changes in the layout defined by the HTML page and frequent changes that can occur to the images 104.

The method 300 includes issuing (step 305) an HTTP request from a browser on a viewer device 26 for an updated image 104. Each request can be limited to a single image 104. Alternatively, multiple indexed image updates can be combined in a single request. Requests can be automatically generated at a predetermined frequency. The frequency can be determined, for example, according to the communication bandwidth of the link between the viewer device 26 and the server 18. Each request, other than a first request, includes a server timestamp indicating the version of the image 104 currently displayed on the viewer display 34.

If it is determined (step 310) that the server timestamp is missing from the request (i.e., the request is a first request), the HTTP response includes sending (step 315) the corresponding image 104 currently available on the server 18 and its server timestamp to the viewer device 26. The viewer device 26 then displays (step 320) the received image and the method 300 returns to step 305 after a predetermined time to issue a new HTTP request.

If it is determined (step 310) that the server timestamp is not missing from the request, the server timestamp of the currently displayed image is compared (step 330) with the server timestamp of the corresponding image on the server 18. If the timestamps are equal, the viewer device 26 continues to display (step 335) the currently displayed image 104 and the method 300 returns to step 305 after the predetermined time to issue a new HTTP request. However, if the timestamps differ because an updated image 104 is available, the HTTP response by the server 18 includes transmitting (step 340) the updated image 104 to the viewer device 26. The updated image 104 is then displayed (step 345) on the viewer device 26 and the method 300 returns to step 305 after the predetermined time to issue a new HTTP request.

While the invention has been shown and described with reference to specific embodiments, it should be understood by those skilled in the art that various changes in form and detail may be made therein without departing from the spirit and scope of the invention.

1. A method for synchronously sharing a dynamically updated image in a sharing display of a sharing computer with a viewer device, the method comprising:
sending an automated HTTP request for an updated image in the sharing display to a server, the server storing a set of images representing at least a portion of the sharing display, the automated HTTP request having a timestamp for an image displayed on the viewer device;
comparing at the server the timestamp of the image displayed on the viewer device with a timestamp of a server image; and
if the timestamp of the image displayed on the viewer device is different from the timestamp of the server image, sending the server image to the viewer device.

2. The method of claim 1 further comprising displaying the server image on the viewer device.

3. The method of claim 1 further comprising posting the updated image from the sharing computer to the server.

4. The method of claim 3 further comprising assigning a timestamp to the posted image.

5. The method of claim 1 further comprising:
sending an automated request for an updated HTML page to the server, the automated request having a timestamp for an HTML page on the viewer device, the server storing an HTML page having a server timestamp and representing the layout of images in at least a portion of the sharing display; and
sending the HTML page stored on the server to the viewer device if the timestamp of the HTML page on the viewer device is different from the timestamp of the HTML page stored on the server.

6. The method of claim 5 wherein the automated request indicates a device environment and further comprising embedding a refresh mechanism in the HTML page prior to sending the HTML page from the server to the viewer device.

7. A computer program product for use with a computer system having a sharing computer, a server and a viewer device, the sharing computer having a sharing display, the computer program product comprising a computer useable medium having embodied therein program code comprising:
program code for sending an automated HTTP request for an updated image in the sharing display to a server, the server storing a set of images representing at least a portion of the sharing display, the automated HTTP request having a timestamp for an image displayed on the viewer device;
program code for comparing the timestamp of the image displayed on the viewer device with a timestamp of a server image; and
program code for sending the server image to the viewer device if the timestamp of the image displayed on the viewer device is different from the timestamp of the server image.

8. The computer program product of claim 7 further comprising program code for displaying the server image on the viewer device.

9. The computer program product of claim 7 further comprising program code for posting the updated image from the sharing computer to the server.

10. The computer program product of claim 7 further comprising:
program code for sending an automated request for an updated HTML page to the server, the automated request having a timestamp for an HTML page on the viewer device, the server storing an HTML page having a server timestamp and representing the layout of images in at least a portion of the sharing display; and
program code for sending the HTML page stored on the server to the viewer device if the timestamp of the HTML page on the viewer device is different from the timestamp of the HTML page stored on the server.

11. The computer program product of claim 10 further comprising program code for embedding a refresh mechanism in the HTML page prior to sending the HTML page from the server to the viewer device.

12. A computer data signal embodied in a carrier wave for use with a computer system having a sharing computer, a server and a viewer device, the sharing computer having a sharing display, the computer data signal comprising:
program code for sending an automated HTTP request for an updated image in the sharing display to a server, the server storing a set of images representing at least a portion of the sharing display, the automated HTTP request having a timestamp for an image displayed on the viewer device;
program code for comparing the timestamp of the image displayed on the viewer device with a timestamp of a server image; and
program code for sending the server image to the viewer device if the timestamp of the image displayed on the viewer device is different from the timestamp of the server image.

13. The computer data signal of claim 12 further comprising program code for displaying the server image on the viewer device.

14. The computer data signal of claim 12 further comprising program code for posting the updated image from the sharing computer to the server.

15. The computer data signal of claim 12 wherein the computer data signal further comprises:
program code for sending an automated request for an updated HTML page to the server, the automated request having a timestamp for an HTML page on the viewer device, the server storing an HTML page having a server timestamp and representing the layout of images in at least a portion of the sharing display; and
program code for sending the HTML page stored on the server to the viewer device if the timestamp of the HTML page on the viewer device is different from the timestamp of the HTML page stored on the server.

16. The computer data signal of claim 15 further comprising program code for embedding a refresh mechanism in the HTML page prior to sending the HTML page from the server to the viewer device

17. An apparatus for synchronously sharing a dynamically updated image in a sharing display of a sharing computer with a viewer device, the apparatus comprising:
means for sending an automated HTTP request for an updated image in the sharing display to a server, the server storing a set of images representing at least a portion of the sharing display, the automated HTTP request having a timestamp for an image displayed on the viewer device;
means for comparing the timestamp of the image displayed on the viewer device with a timestamp of a server image; and
means for sending the server image to the viewer device if the timestamp of the image displayed on the viewer device is different from the timestamp of the server image.

18. The apparatus of claim 17 further comprising:
means for sending an automated request for an updated HTML page to the server, the automated request having a timestamp for an HTML page on the viewer device, the server storing an HTML page having a server timestamp and representing the layout of images in at least a portion of the sharing display; and
means for sending the HTML page stored on the server to the viewer device if the timestamp of the HTML page on the viewer device is different from the timestamp of the HTML page stored on the server.
